(19) United States
(12) Patent Application Publication
(10) Pub. No.: US 2026/0251269 A1
(43) Pub. Date: Aug. 27, 2026

(54) ASSEMBLY FOR STORING A LIQUEFIED CRYOGENIC FLUID, VEHICLE AND METHOD

(71) Applicant: L'Air Liquide, Societe Anonyme pour l'Etude et l’Exploitation des Procedes Georges Claude, Paris (FR)

(72) Inventors: Pierre BARJHOUX, Paris (FR); Robin CHANEAC, Paris (FR)

(21) Appl. No.: 19/552,254

(22) Filed: Feb. 27, 2026

(30) Foreign Application Priority Data
Feb. 27, 2025 (FR) 2501998

(51) Int. Cl. F17C 9/04

(52) U.S. Cl. CPC F17C 9/04; F17C 2221/033; F17C 2223/0161; F17C 2270/0105

(57) ABSTRACT

The invention relates to an assembly for storing a liquefied cryogenic fluid, to a boat and to a method, comprising a cryogenic tank, a line for withdrawing cryogenic fluid from the cryogenic tank and comprising a heat exchanger for heating the withdrawn cryogenic fluid, a device for cooling the cryogenic fluid in the cryogenic tank comprising a cycle cryogenic refrigerator, the refrigerator comprising a cycle circuit comprising a cycle fluid and a cycle-fluid compression section comprising at least one compressor, a cycle-fluid cooling section comprising at least one heat exchanger, a cycle-fluid expansion section comprising at least one turbine and/or valve, and a cycle-fluid heating section comprising at least one heat exchanger, the cycle-fluid cooling section comprising heat exchange between the cycle circuit and the heating heat exchanger of the withdrawal line.

### CROSS REFERENCE TO RELATED APPLICATIONS

This application claims the benefit of priority under 35 U.S.C. § 119 (a) and (b) to French patent application No. FR2501998, filed Feb. 27, 2025, which is herein incorporated by reference in its entirety.

### FIELD OF THE INVENTION

The invention relates to an assembly for storing a cryogenic fluid, to a vehicle comprising such an assembly and to a method.

More particularly, the invention relates to an assembly for storing a liquefied cryogenic fluid, for example hydrogen, comprising a cryogenic tank configured to store the cryogenic fluid, a line for withdrawing fluid from the tank and comprising an upstream end connected to the tank and a downstream end designed to be connected to a user, for example an engine using the fluid, the fluid withdrawal line comprising a heat exchanger for heating the withdrawn fluid, the storage assembly comprising a device for cooling the cryogenic fluid in the tank comprising a refrigerant-cycle cryogenic refrigerator provided with a cooling heat exchanger configured to provide cooling power to the fluid in the tank, the refrigerator comprising a cycle circuit comprising a cycle fluid and configured to subject the cycle fluid to a thermodynamic cycle in order to produce cold power, the cycle circuit comprising a cycle-fluid compression section comprising at least one compressor, a cycle-fluid cooling section comprising at least one heat exchanger, a cycle-fluid expansion section comprising at least one turbine and/or valve, and a cycle-fluid heating section comprising at least one heat exchanger.

### BACKGROUND OF THE INVENTION

It is known to cool or subcool cryogenic liquid (such as an LNG or LH2 fuel, for example) in tanks that can be carried, in particular, on board boats. It is also known to liquefy the boil-off gas in such tanks. This cooling is generally carried out via a cycle refrigerator in which the drive members that control the compressors are generally of the electric type. The electricity can be produced by the combustion of this combustible gas, which can be drawn from the tank (heated, possibly vaporized). The efficiency of such an assembly can therefore be defined at least in part by the consumption of this combustible gas.

### SUMMARY OF THE INVENTION

An object of the present invention is to improve the effectiveness or efficiency of such an assembly.

To this end, the assembly according to the invention, which is otherwise in accordance with the generic definition thereof given in the preamble above, is essentially characterized in that the cycle-fluid cooling section comprises heat exchange between the cycle circuit and the heating heat exchanger of the withdrawal line.

Furthermore, embodiments of the invention may have one or more of the following features:
the passage of the bypass line in the heating heat exchanger of the withdrawal line is in countercurrent to the flow of fluid withdrawn from the tank,
the cycle circuit comprises a plurality of bypass lines forming a plurality of passages in the heating heat exchanger of the withdrawal line, the first ends of the different bypass lines being connected downstream of respective separate compressors,
the heat exchanger for heating the withdrawn fluid comprises or consists of a heat exchanger of the cycle-fluid cooling section of the cycle circuit,
the heat exchanger for heating the withdrawn fluid is a heat exchanger of the cycle-fluid cooling section disposed downstream of the compression section and upstream of at least one turbine and/or one valve of the expansion section of the cycle circuit,
the heat exchanger for heating the withdrawn fluid is a heat exchanger of the cycle-fluid heating section of the cycle circuit and is disposed downstream of the cooling heat exchanger, meaning that the heat exchanger for heating the withdrawn fluid is a heat exchanger that is common to the cycle-fluid cooling section and to the cycle-fluid heating section and simultaneously ensures heat exchange between a first flow of relatively hot cycle gas, a second flow of relatively colder cycle fluid, and the withdrawn gas flow,
the fluid withdrawal line comprises an expansion member for expanding the fluid flow, for example a turbine configured to expand the fluid flow withdrawn from the tank and thus to produce cold power that is supplied to the heating heat exchanger,
the expansion member of the withdrawal line is a turbine connected to a generator configured to produce electricity which supplies an electrical member of the assembly, for example an electric motor driving a compressor of the compression section and/or mechanically coupled to a rotary compressor of the compression section,
the fluid withdrawal line comprises a fluid suction member, for example a pump disposed in the lower part of the storage volume of the tank and/or a compressor connected to the upper part of the storage volume of the tank,
the fluid withdrawal line comprises, downstream of the heating heat exchanger, at least one compressor and/or at least one additional heat exchanger,
the device for cooling the cryogenic fluid in the tank comprises a sampling line having, between upstream and downstream ends connected to the tank, a portion in heat exchange with the cooling heat exchanger of the refrigerator, the sampling line being configured to draw fluid from the tank, cool it and inject it into the tank.

The invention also relates to a vehicle for transporting a liquefied cryogenic fluid, for example a boat, comprising an assembly for storing a liquefied cryogenic fluid in accordance with any one of the features above or below.

The invention also relates to a method for storing a liquefied cryogenic fluid using such an assembly or such a transport vehicle, the method comprising a step of cooling the cryogenic fluid from the tank via the refrigerator, during which the cycle fluid of the refrigerator is cooled, a step of withdrawing cryogenic fluid from the tank towards a user, a step of heating the withdrawn cryogenic fluid, in which at least some of the cooling of the cycle fluid of the refrigerator and at least some heating of the withdrawn cryogenic fluid are carried out jointly by heat exchange between withdrawn cryogenic fluid and cycle fluid.

According to other possible particular features:
the cooling of the cycle fluid of the refrigerator carried out jointly with the heating of the withdrawn cryogenic fluid is the cooling of the cycle fluid at the outlet of at least one compression stage,
the cryogenic fluid is a fuel, for example hydrogen (H2) or natural gas containing predominantly methane (CH4), the user comprising an engine for combustion of said fluid.

### BRIEF DESCRIPTION OF THE DRAWINGS

The invention will be understood better from reading the following description and from studying the accompanying figures. These figures are given only by way of illustration and do not in any way limit the invention.

Further particular features and advantages will become apparent upon reading the following description, which is provided with reference to the figures, in which:

FIG. 1 is a schematic partial view illustrating a first example of the structure and operation of the invention,

FIG. 2 is a schematic partial view illustrating a second example of the structure and operation of the invention,

FIG. 3 is a schematic partial view illustrating a third example of the structure and operation of the invention.

### DETAILED DESCRIPTION OF THE INVENTION

Throughout the figures, the same reference signs relate to the same elements. In this detailed description, the following embodiments are examples. Although the description refers to one or more embodiments, this does not mean that the features apply only to one embodiment. Individual features of different embodiments can also be combined and/or interchanged in order to provide other embodiments.

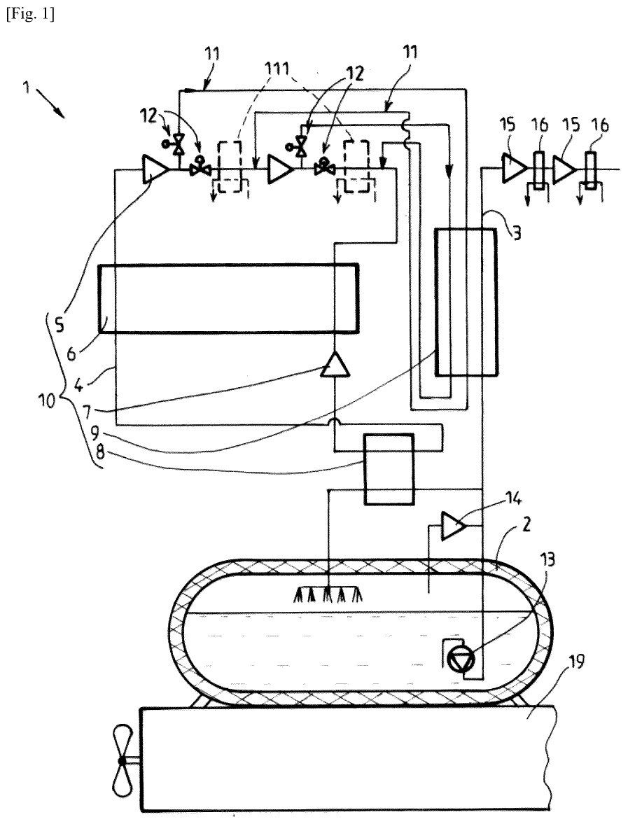

FIG. 1 schematically illustrates an assembly for storing a liquefied cryogenic fluid, for example liquefied hydrogen (LH2) or liquefied natural gas (LNG). As shown schematically, it is possible for this assembly not to be fixed but to be carried on board a vehicle, for example a boat 19.

The assembly 1 comprises at least one cryogenic tank 2 configured to store the cryogenic fluid, for example a thermally insulated cryogenic tank under vacuum or based on other technical solutions that are typically employed for on-board LNG applications. The assembly comprises at least one line 3 for withdrawing fluid from the tank, comprising an upstream end connected to the storage volume of the tank 2 and a downstream end intended to be connected to a user, for example a propulsion engine of the vehicle using the fluid as fuel. In the possible example illustrated, the withdrawal line 3 comprises two upstream ends connected respectively to the lower portion and upper portion of the storage volume in order to withdraw liquid and gas, respectively. The upstream end accommodated in the lower part of the tank 2 comprises, for example, a submerged pump 13 for suction of the liquid. The end opening into the upper part of the tank 2 may comprise a member 14 for compressing the gas from the gas headspace, this member 14 (for example a cryogenic compressor) being located, for example, outside the tank 2.

The line 3 passes through a heat exchanger 9 for heating the withdrawn fluid (for example a vaporizer). Downstream, the withdrawal line 3 may comprise one or more compressors 15 and one or more heat exchangers 16 for heating or cooling as required in order to supply the user with the gas at the appropriate temperature and pressure.

The assembly 1 (or installation) also comprises a device for cooling the cryogenic fluid in the tank 2. This cooling device comprises a refrigerant cycle cryogenic refrigerator 10 provided with a cooling heat exchanger 8 configured to provide cooling power to the fluid in the tank 2 (in order to cool or subcool it or liquefy a fraction of its gas phase).

In the example illustrated, the cryogenic fluid in the tank 2 is cooled via a sampling line 17 having, between upstream and downstream ends connected to the tank 2, a portion in heat exchange with the cooling heat exchanger 8 of the refrigerator 10. For example, the sampling line 17 may be configured to draw fluid from the tank 2 (liquid and/or gas), cool it outside the tank 2 and return it to the tank 2 (cooled or liquefied, for example, in the upper part via an injection and/or sprinkler rail and/or in the lower part of the tank 2).

As illustrated, at least a part of the sampling line 17 may be shared with a part of the withdrawal line (in particular the end or ends connected to the storage volume with the pumping member 13 and/or compression member 14).

Of course, the invention is not limited to this example. Thus, the cooling and/or liquefaction of the fluid in the tank 2 can be carried out in the tank 2. In this case, at least part of the cooling exchanger 8 could be situated in the tank 2.

The refrigerator 10 comprises a cycle circuit 4 comprising a cycle fluid (for example comprising at least one of: neon, argon, helium, nitrogen, oxygen and hydrogen (H2)) and configured to subject the cycle fluid to a thermodynamic cycle in order to produce cold power at at least one cold end of the cycle circuit 4, in particular at the cooling heat exchanger 8.

The cycle circuit 4 comprises a cycle-fluid compression section comprising at least one compressor 5 (and, for example, a plurality of compressors in series and/or in parallel), a cycle-fluid cooling section comprising at least one heat exchanger, a cycle-fluid expansion section 7 comprising at least one turbine and/or one valve (and, for example, a plurality of turbines and/or valves in series and/or in parallel) and a cycle-fluid heating section 8, 6 comprising at least one heat exchanger. The cooling section and the heating section may, in particular, comprise at least one common exchanger that simultaneously effects the cooling of a cycle gas flow by heat exchange (for example in countercurrent) with another, cooler cycle gas flow, which is thus heated. The cooling section may also comprise at least one cooling heat exchanger 111 located at the outlet of at least one of the compressors and configured to cool the cycle-fluid flow heated by the compression. Downstream of the expansion section, the cooling heat exchanger 8 also heats the cycle fluid during the heat exchange with the application (the fluid) to be cooled.

According to one advantageous particular feature, the cycle-fluid cooling section (and in particular the cooling section at the outlet of the compressor or compressors) comprises heat exchange between the cycle circuit 4 and the heating heat exchanger 9 of the withdrawal line 3. This means that at least a part of the cooling of the cycle fluid (for example after compression) can be carried out by a flow of relatively colder fluid withdrawn from the tank 2.

To this end, the cycle circuit 4 may comprise at least one bypass line 11 providing a passage through the heating heat exchanger 9 of the withdrawal line 3, for example downstream of a compressor 5. In the example illustrated, a plurality of bypass lines 11 (two) are provided downstream respectively of (two) compressors 5 or compression stages. This means that at least a part of the cooling between compression stages can be provided by the heating heat exchanger 9 (instead of using, as conventionally, a heat transfer fluid such as water or air).

Each bypass line 11 may have an end connected downstream of a compressor 5 and then a passage through the heating heat exchanger 9 of the withdrawal line 3, and a downstream end connected to the cycle circuit 4 downstream of the first end. As a variant or in combination, only one part of this cycle fluid is drawn by the bypass line 11 for exchange with the heating heat exchanger 9. This heated flow could then be remixed with the remainder of the cycle-fluid flow (not drawn) before entering the next compressor.

As illustrated, the passage through the heat exchanger 9 may be in countercurrent to the flow of withdrawn fluid circulating in the withdrawal line 3. The cycle circuit 4 comprises, for example, an isolation valve 12, for example on the bypass line 11, making it possible to control the flow of cycle gas in the bypass line 11 (for example, in order to allow or not allow it to circulate in the heat exchanger 9 and possibly to regulate its flow rate).

Thus, a portion of the frigories of the fluid withdrawn from the tank 2 is used in the refrigeration cycle, for example for cooling the cycle fluid at the outlet of the compression stage(s), for example to ambient temperature. The relatively hot temperature of the cycle is reduced, thereby improving the compression effectiveness and the efficiency of the refrigerator compared with a Carnot dithermic cycle. The energy consumption (in particular electrical in the case of compressors driven by electric motors for the same need for cold heat extraction) can be reduced by about 8 to 12% compared with known solutions.

At least some of the cooling exchangers 111 usually provided at the compression outlet may be omitted.

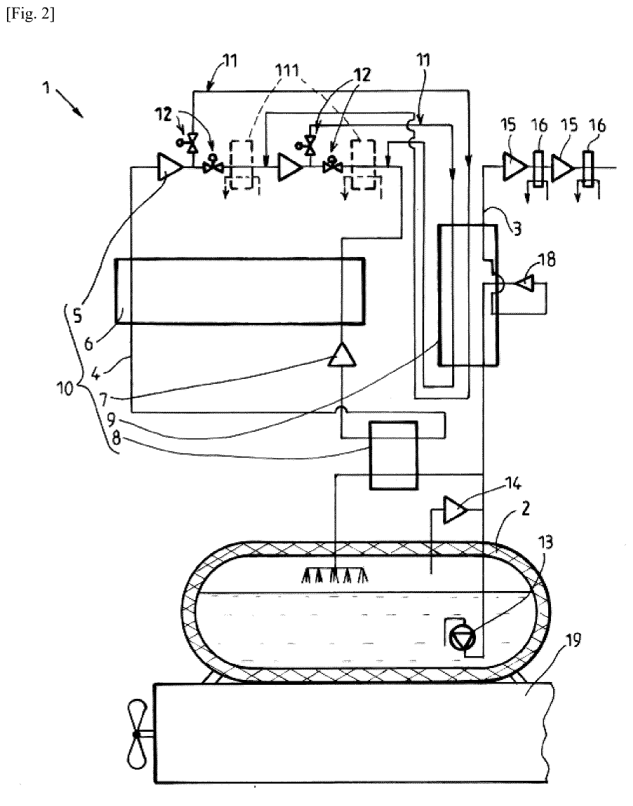

The example in FIG. 2 differs from the one described above only in that the fluid withdrawal line 3 comprises an expansion member 18 for expanding the fluid flow, for example an expansion turbine configured to expand the flow of fluid withdrawn from the tank 2 and thus to produce cold power which is supplied to the heating heat exchanger 9. For example, the flow of fluid withdrawn from the tank 2 is pumped at a pressure of between 5 bara and 80 bara and, before or during its circulation in the cooling exchanger 9, it is expanded in a turbine 18 in order to recover the cold which has been given up to the cooling exchanger 9 downstream of the expansion. As illustrated, before returning into the withdrawal line 3, the flow expanded in this turbine 18 can pass through the heating heat exchanger 9 at a lower temperature than at the point of entry (suction) into said turbine 18. This means that the flow expanded by the turbine 18 returns into the heating heat exchanger 9 upstream of the bifurcation of the line 3 towards the intake of the turbine 18.

In addition, this expansion turbine 18 can extract work during the expansion. This mechanical work may be used as the power supply of the compressors 5 or compression stages of the refrigeration cycle 10.

This turbine 18 can be connected to a generator configured to produce electricity which supplies one or more electrical members of the assembly, for example an electric motor driving (a) compressor(s). This further increases the efficiency of the installation. This turbine 18 can be designed to produce the electricity necessary (entirely or in part) for the reliquefaction function and can use the same turbomachine technology as those used in the refrigerator 10.

In addition, this expansion turbine 18 can be mechanically coupled to the compressors 5 or compression stages of the refrigeration cycle in the manner of single-shaft turbocompressors, for example.

As a variant or in combination, a cycle of the Rankine type can be provided in order to recover the power of the relatively hot flows at the cycle-fluid compression outlet and of the relatively cold flow of the fluid flow withdrawn from the tank 2. This also increases the effectiveness of the Carnot cycle of the assembly.

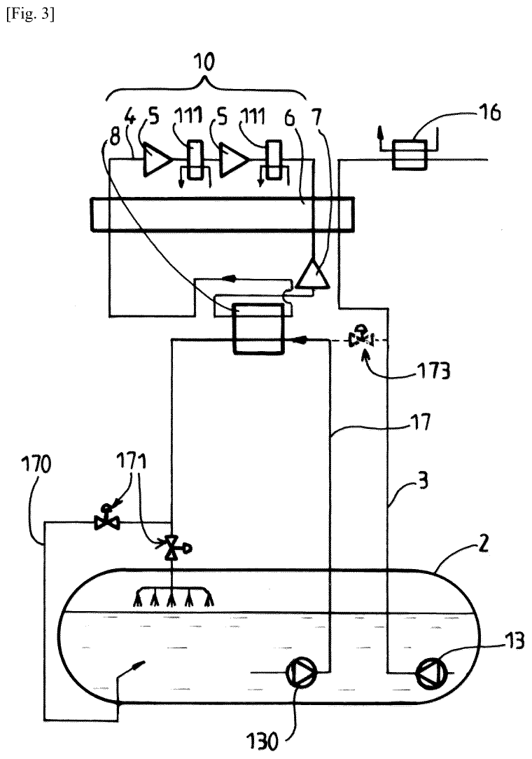

The example in FIG. 3 differs from the one in FIG. 1 essentially in that the heat exchanger 9 for heating the withdrawn fluid is made up of a heat exchanger of the cycle-fluid cooling section of the cycle circuit 4. This means that there is no heat exchanger dedicated to heating the withdrawn fluid, but rather, this function is ensured by a heat exchanger of the cycle circuit 4 of the refrigerator 10 (via at least one passage of the withdrawn fluid flow in a heat exchanger 9 of the cycle circuit 4 of the refrigerator). By contrast, in known solutions, there is traditionally, on board the boat, a vaporizer exchanger function integrating a hot source such as a cooling water circuit, entailing risks of the latter freezing in the event of any malfunction of this same heat exchanger.

As illustrated, the heat exchanger 9 for heating the withdrawn fluid may be a heat exchanger of the cycle-fluid cooling section disposed downstream of the compression section and upstream of at least one turbine and/or one valve of the expansion section 7 of the cycle circuit 4. This heat exchanger 9 for heating the withdrawn fluid may, in particular, be an exchanger that ensures both the heating of the cycle fluid and, at the same time, the cooling of the cycle fluid. As illustrated, this heat exchanger 9 can simultaneously exchange heat (for example in countercurrent) between a first flow of relatively hot cycle gas leaving the compression section and before expansion 7 and a second flow of relatively colder cycle fluid exiting, for example, the cooling exchanger 8 before returning into the compression section. This heat exchanger 9 comprises an additional passage for the withdrawn fluid flow to be heated.

As illustrated in FIG. 3, the sampling line 17 may be separate from the withdrawal line 3 and may, in particular, comprise a separate upstream end provided with a pumping member 130 separate from that of the withdrawal line 3. In particular, the pumping member 130 of the sampling line may be a submerged pump in the lower part having a relatively greater flow rate and generating relatively lower pressurization of the pumped fluid than the pump 13 of the withdrawal circuit 3.

In addition, as illustrated in FIG. 3, the sampling line 17 may comprise a bypass 170 at its downstream end and a set of valve(s) 171 making it possible to return the pumped and cooled fluid into the cooling exchanger 8 in the upper part of the tank (in the gaseous part, for example via one or more nozzles) and/or in the lower part (in the liquid phase).

In addition, as illustrated schematically by way of dashed lines, a connection 173 (preferably provided or associated with a valve) can be provided between the withdrawal line 3 and the sampling line 17 (for example upstream of the cooling exchanger 8) in order to allow fluid transfer between the lines.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. An assembly for storing a liquefied cryogenic fluid, for example hydrogen, the assembly comprising:
a cryogenic tank configured to store the cryogenic fluid,
a cryogenic fluid withdrawal line configured to withdraw the cryogenic fluid from the cryogenic tank and comprising an upstream end connected to the cryogenic tank and a downstream end configured to be connected to an engine using the cryogenic fluid, the cryogenic fluid withdrawal line comprising a heat exchanger configured to heat the withdrawn cryogenic fluid,
a cooling device configured to cool the cryogenic fluid in the cryogenic tank, the cooling device comprising a refrigerant-cycle cryogenic refrigerator provided with a cooling heat exchanger configured to provide cooling power to the cryogenic fluid in the cryogenic tank, wherein the refrigerant-cycle cryogenic refrigerator comprising a cycle circuit comprising:
a cycle fluid and configured to subject the cycle fluid to a thermodynamic cycle in order to produce cold power,
a cycle-fluid compression section comprising at least one compressor,
a cycle-fluid cooling section comprising at least one heat exchanger,
a cycle-fluid expansion section comprising at least one turbine and/or valve, and
a cycle-fluid heating section comprising at least one heat exchanger,
wherein the cycle-fluid cooling section comprises heat exchange between the cycle circuit and the heating heat exchanger of the cryogenic fluid withdrawal line.

2. The assembly according to claim 1, wherein the cycle circuit comprises a bypass line having a first end connected downstream of a compressor, a passage through the heating heat exchanger of the withdrawal line, and a second end connected to the cycle circuit downstream of the first end, the cycle circuit comprising a set of valve(s) configured to control the flow of cycle gas in the bypass line.

3. The assembly according to claim 2, wherein the passage of the bypass line in the heating heat exchanger of the withdrawal line is in countercurrent to the flow of cryogenic fluid withdrawn from the cryogenic tank.

4. The assembly according to claim 2, wherein the cycle circuit comprises a plurality of bypass lines forming a plurality of passages in the heating heat exchanger of the withdrawal line, the first ends of the different bypass lines being connected downstream of respective separate compressors.

5. The assembly according to claim 1, wherein the heat exchanger for heating the withdrawn cryogenic fluid comprises or consists of a heat exchanger of the cycle-fluid cooling section of the cycle circuit.

6. The assembly according to claim 5, wherein the heat exchanger for heating the withdrawn cryogenic fluid is a heat exchanger of the cycle-fluid cooling section disposed downstream of the compression section and upstream of at least one turbine and/or one valve of the expansion section of the cycle circuit.

7. The assembly according to claim 6, wherein the heat exchanger for heating the withdrawn cryogenic fluid is a heat exchanger of the cycle-fluid heating section of the cycle circuit and is disposed downstream of the cooling heat exchanger, meaning that the heat exchanger for heating the withdrawn cryogenic fluid is a heat exchanger that is common to the cycle-fluid cooling section and to the cycle-fluid heating section and simultaneously ensures heat exchange between a first flow of relatively hot cycle gas, a second flow of relatively colder cycle fluid, and the withdrawn gas flow.

8. The assembly according to claim 1, wherein the cryogenic fluid withdrawal line comprises an expansion member for expanding the cryogenic fluid flow, for example a turbine configured to expand the cryogenic fluid flow withdrawn from the cryogenic tank and thus to produce cold power that is supplied to the heating heat exchanger.

9. The assembly according to claim 8, wherein the expansion member of the withdrawal line is a turbine connected to a generator configured to produce electricity which supplies an electrical member of the assembly, for example an electric motor driving a compressor of the compression section and/or mechanically coupled to a rotary compressor of the compression section.

10. The assembly according to claim 1, wherein the cryogenic fluid withdrawal line comprises a cryogenic fluid suction member, for example a pump disposed in the lower part of the storage volume of the cryogenic tank and/or a compressor connected to the upper part of the storage volume of the cryogenic tank.

11. The assembly according to claim 1, wherein the cryogenic fluid withdrawal line comprises, downstream of the heating heat exchanger, at least one compressor and/or at least one additional heat exchanger.

12. The assembly according to claim 1, wherein the device for cooling the cryogenic fluid in the cryogenic tank comprises a sampling line having, between upstream and downstream ends connected to the cryogenic tank, a portion in heat exchange with the cooling heat exchanger of the refrigerator, the sampling line being configured to draw cryogenic fluid from the cryogenic tank, cool it and inject it into the cryogenic tank.

13. A vehicle configured to transport a liquefied cryogenic fluid, the vehicle comprising the assembly according to claim 1.

14. A method for storing a liquefied cryogenic fluid comprising the steps of:
providing the assembly according to claim 1;
cooling the cryogenic fluid from the cryogenic tank via the refrigerator, during which the cycle fluid of the refrigerator is cooled;
withdrawing cryogenic fluid from the cryogenic tank towards a user; and
heating the withdrawn cryogenic fluid, in which at least some of the cooling of the cycle fluid of the refrigerator and at least some heating of the withdrawn cryogenic fluid are carried out jointly by heat exchange between withdrawn cryogenic fluid and cycle fluid.

15. The method according to claim 14, wherein the cooling of the cycle fluid of the refrigerator carried out jointly with the heating of the withdrawn cryogenic fluid is the cooling of the cycle fluid at the outlet of at least one compression stage.

16. The method according to claim 14, wherein the cryogenic fluid is a fuel, for example hydrogen or natural gas containing predominantly methane, the user comprising an engine for combustion of said cryogenic fluid.
